(19) United States
(12) Patent Application Publication
(10) Pub. No.: US 2008/0275747 A1
(43) Pub. Date: Nov. 6, 2008

(54) INCIDENT/ACCIDENT REPORT ANALYSIS APPARATUS AND METHOD

(75) Inventors: Takeichiro NISHIKAWA, Yokohama-shi (JP); Kentaro TORII, Yokohama-shi (JP)

Correspondence Address: Charles N. J. Ruggiero, Esq.;Ohlandt, Greeley, Ruggiero & Perle, L.L.P., One Landmark Square, 10th Floor, Stamford, CT, 06901-2682, US

(73) Assignee: KABUSHIKI KAISHA TOSHIBA

(21) Appl. No.: 12/105,004

(22) Filed: Apr. 17, 2008

(30) Foreign Application Priority Data
Apr. 20, 2007 (JP) 2007-112258

(51) Int. Cl. G06Q 10/00; G06Q 50/00

(52) U.S. Cl. 705/7

(57) ABSTRACT

An incident/accident report analysis apparatus is disclosed. An input unit inputs an incident/accident report containing a crisis rate and an severity of an incident/accident. A probability value corresponding to the crisis rate and a loss amount corresponding to the severity is recorded in a data table. A parameter storage unit stores an N value indicating the number of times a failure occurs and an α value indicating a risk tolerance parameter. A risk calculation unit calculates a incident risk including the loss amount occurring with the probability of α% upon repetition of the same failure N times, using the probability value corresponding to the crisis rate and the loss amount corresponding to the severity.

### CROSS-REFERENCE TO RELATED APPLICATIONS

This application is based upon and claims the benefit of priority from prior Japanese Patent Application No. 2007-112258, filed Apr. 20, 2007, the entire contents of which are incorporated herein by reference.

### BACKGROUND OF THE INVENTION

1. Field of the Invention

The present invention relates to an incident/accident report analysis wherein failure mode and effects analysis (FMEA) is performed.

2. Description of the Related Art

The incident report is of two types, description type and selection type. In the incident report of description type, a risk manager is required to read and understand the contents thereof and the statistical analysis is difficult. The incident report of selection type, on the other hand, includes the famous format of the Japan Council for Quality Health Care which discloses the analysis result on Web. As FMEA for medical applications, HFMEA (Healthcare Failure Mode and Effects Analysis) is famous and widely used by US medical organizations (See Takahiro Soma, “Application of FMEA (Failure Mode and Effects Analysis) to Medical Areas”, and J. Derosier, E. Stalhandske, J. P. Bagian, T. Nudell: “Using Health Care Failure Mode and Analysis”, Journal on Quality Improvement, May, 2002, <URL: www.va.gov/ncps/HFMEA.html>).

In the incident/accident report, the magnitude of the latent problem hidden in a minor incident is difficult to evaluate, and there is a problem that if measures are taken against all incidents, the work process becomes too complex. In order to take an effective measure, a system is required for objectively evaluating a job harboring a large latent problem.

### BRIEF SUMMARY OF THE INVENTION

An incident/accident report analysis apparatus according to an aspect of the present invention comprises: an input unit which inputs an incident/accident report containing a crisis rate and an severity of an incident/accident; a data table having recorded therein a crisis probability corresponding to the crisis rate and a loss amount corresponding to the severity; a parameter storage unit having stored therein an N value indicating the number of times a failure occurs and an α value indicating a risk tolerance parameter; and a risk calculation unit which calculates a incident risk that is the loss amount occurring with the probability of α% upon repetition of the same failure N times, using the crisis probability corresponding to the crisis rate and the loss amount corresponding to the severity.

### BRIEF DESCRIPTION OF THE SEVERAL VIEWS OF THE DRAWING

FIG. 1 is a block diagram showing an incident/accident report analysis apparatus according to a first embodiment;

FIG. 2 is a diagram showing an example of an input screen for incident discovery information;

FIG. 3 is a diagram showing an example of definition of an incident level;

FIG. 4 is a diagram showing an example of an input screen for incident occurrence information;

FIG. 5 is a diagram showing an example of a occurrence, detectability and crisis rate stored in a data table;

FIG. 6 is a diagram showing an example of an severity stored in the data table;

FIG. 7 is a diagram showing an example of the information accumulated in a report database;

FIG. 8 is a diagram showing an example of a FMEA table;

FIG. 9 is a diagram showing an analysis result of an incident/accident report;

FIG. 10 is a block diagram showing an incident/accident report analysis apparatus according to a second embodiment;

FIG. 11 is a diagram showing an example of display of the result calculated in a report analysis unit; and

FIG. 12 is a diagram showing an example of a candidate display by a candidate calculation unit T11.

### DETAILED DESCRIPTION OF THE INVENTION

### First Embodiment

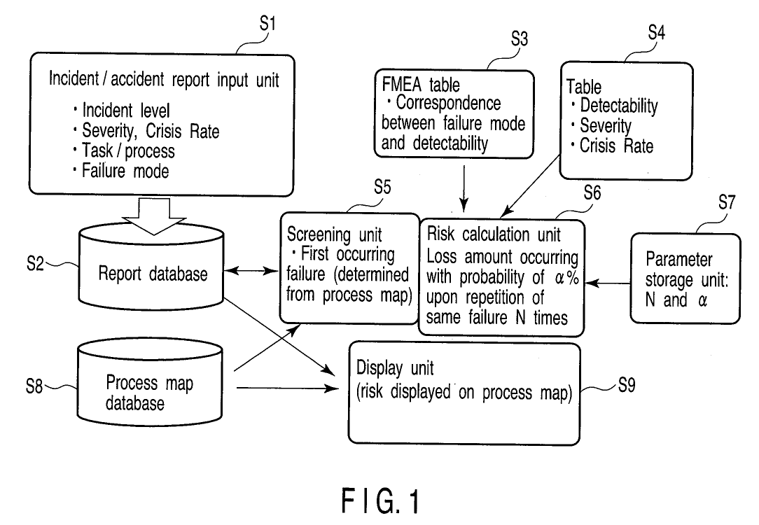

Referring to FIG. 1, an incident/accident report analysis apparatus according to the first embodiment can be implemented as, for example, computer software and, in the case where the same failure is repeated N times, can calculate the incident risk generated with the probability of 1% and display by totalizing them for each process or task.

As shown in FIG. 1, the incident/accident report analysis apparatus includes an incident/accident report input unit S1 for inputting an incident/accident report (this embodiment is explained especially with reference to a case handling an incident report), a report database S2 for accumulating the input incident reports, a FMEA table S3 for recording each failure mode in correspondence with at least the information on the detectability and the crisis rate, a data table S4 having recorded therein the probability values corresponding to the detectability, the severity and the crisis rate and the loss amount corresponding to the severity, a parameter storage unit S7 having stored therein the number of times (N) a failure occurs and a risk tolerance parameter (α), and a risk calculation unit S6 for calculating the loss amount (incident risk) generated with the probability of α% upon repetition of the same failure N times, with reference to the incident reports accumulated in the report database S2, the FMEA table S3, the data table S4 and the parameters of the parameter storage unit S7.

Also, the incident/accident report analysis apparatus includes a display unit S9 for totalizing the incident reports for each task obtained from the process map information accumulated in a process map database S8 and displaying them in a color corresponding to the magnitude of the loss amount (incident risk) of each incident.

The procedure for carrying out a Risk FMEA (RFMEA) with the incident/accident report analysis apparatus configured as described above will be explained below. Especially, this embodiment deals with the steps of the procedure from the input of the incident report to the calculation and display of the incident risk.

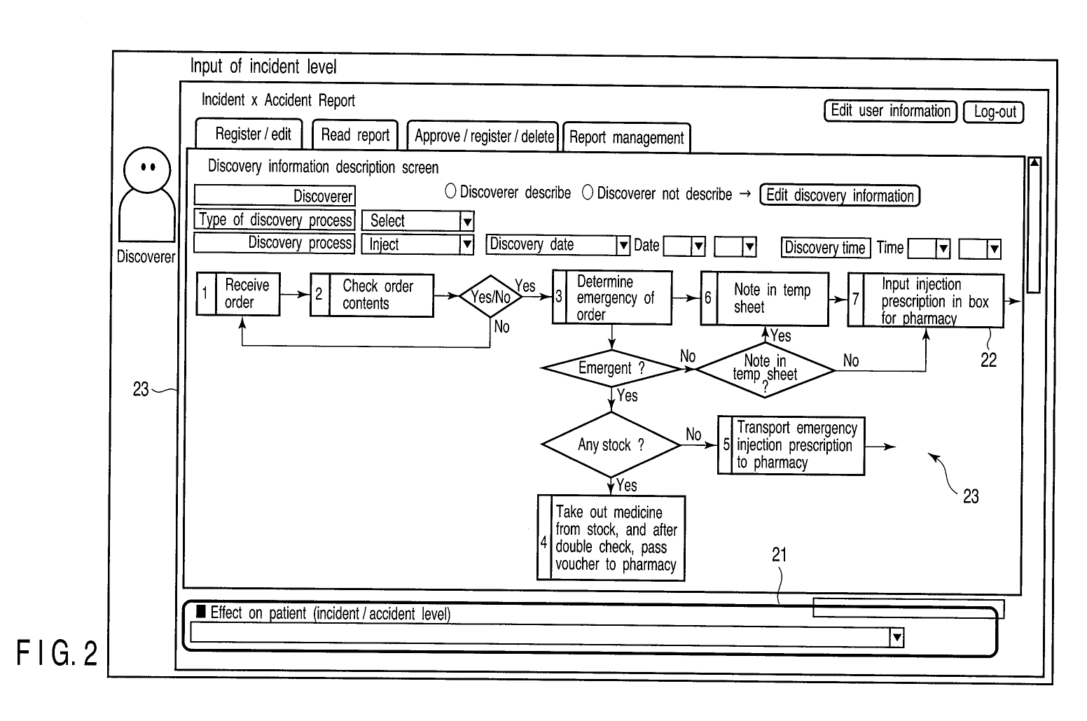

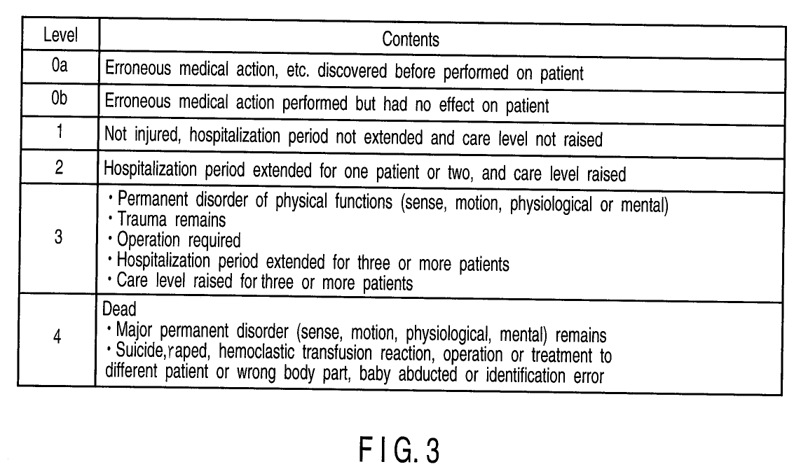

(Step 1): The discoverer of an incident inputs the incident discovery information through the incident/accident report input unit S1. In this case, a discovery information input screen 20 as shown in FIG. 2 is displayed. On the discovery information input screen 20, for example, the discoverer selects a task 22 for which an incident was discovered, on a process map 23 and inputs discovery information 21 including the effect (incident level) on the patient. FIG. 3 shows a definition example of the incident level. In this incident level definition example, an incident level 0a corresponds to an incident discovered before committing some failure (erroneous medical action), and level 0b and subsequent levels correspond to an incident/accident that has actually occurred. The contents of the incidents of the level 1 and subsequent levels are the information identical with the severity described later.

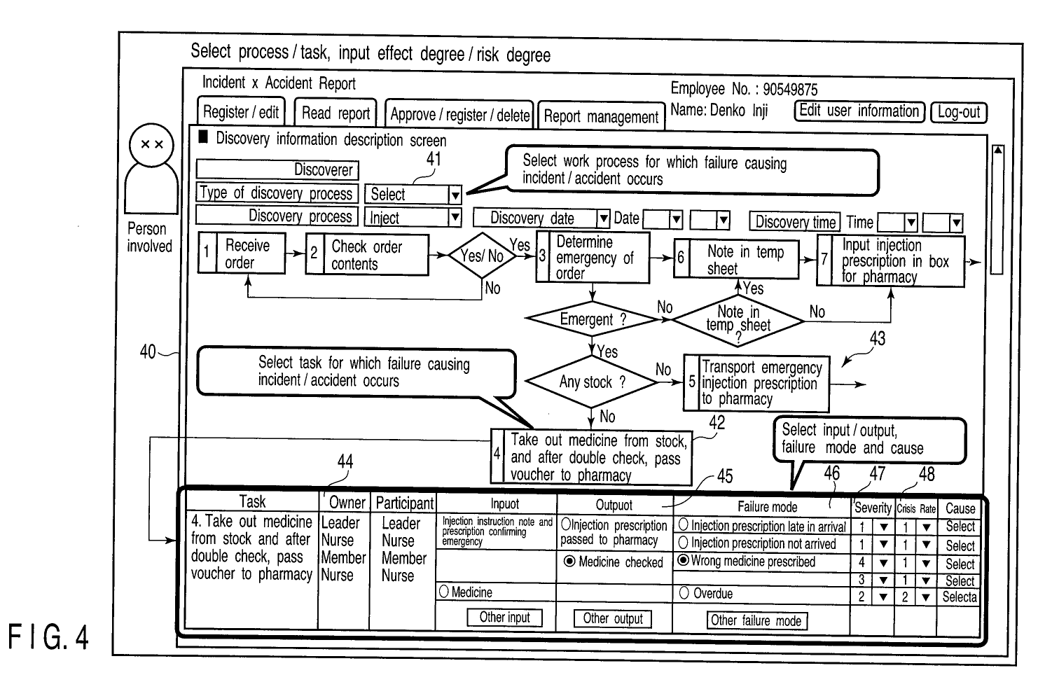

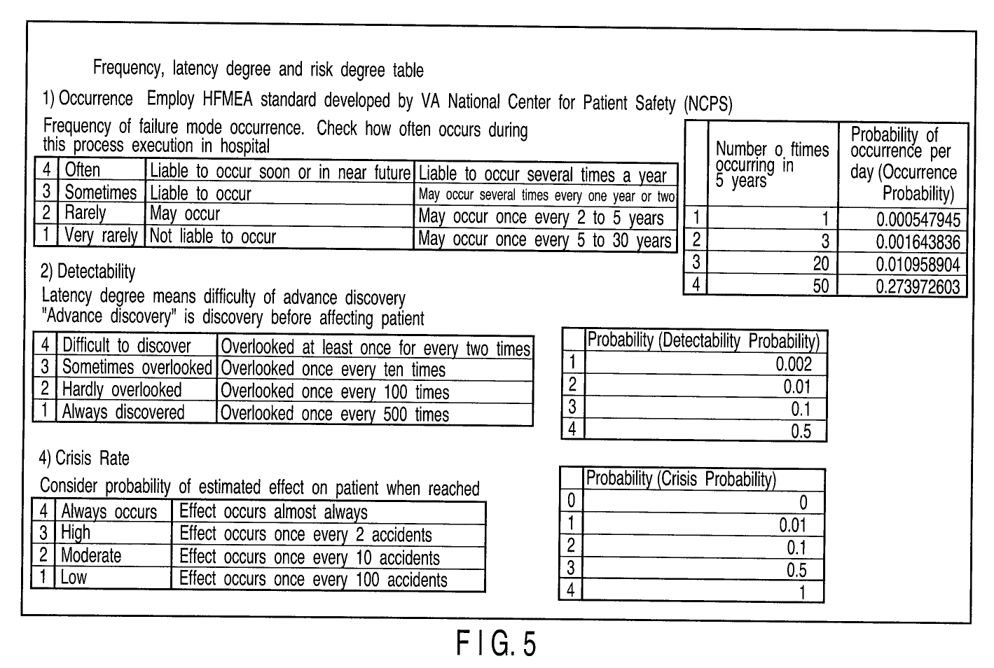

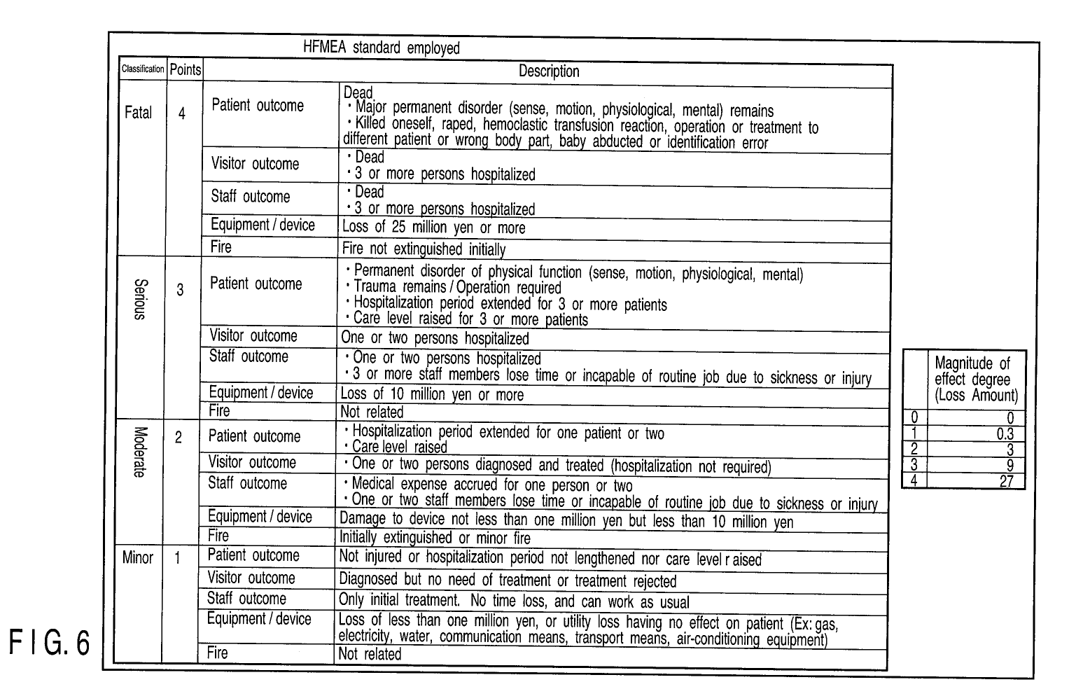

(Step 2): The person who has committed an error inputs the incident occurrence information through the incident/accident report input unit S1. The person involved selects, for example, a process 41 on an occurrence information input screen 40 shown in FIG. 4 and a task 42 for which the failure has occurred, on a process map 43. Then, a table 44 corresponding to the task 42 is displayed in the lower part of the screen. The person involved selects the radio buttons including an output 45 and a failure mode 46 in that order in the table 44 on the occurrence information input screen 40. Further, the person involved selects an severity 47 and a crisis rate 48 in the table 44. The severity 47 and the crisis rate 48 are defined in FIGS. 5 and 6.

An example of the contents of the data table S4 for storing the information on the occurrence, detectability and crisis rate is shown in FIG. 5. The occurrence is defined as the rate at which the failure mode occurs. The detectability is defined as the degree of difficulty of advance discovery. The “advance discovery” is defined as the discovery before the patient is affected. The crisis rate is defined as the probability with which an estimated effect occurs when the failure reaches the patient. FIG. 6 shows the information on the severity stored in the data table S4. The severity indicates the degree of the effect on the patient.

The contents of the table 44 on the occurrence information input screen 40 are recorded in the FMEA table S3.

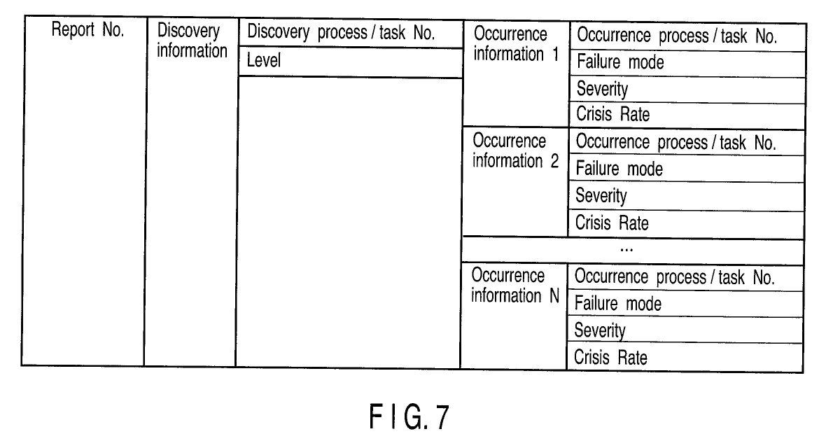

(Step 3): The information input from the incident/accident report input unit S1 is accumulated in the report database S2. The information thus accumulated is shown in FIG. 7. As understood from FIG. 7, the incident/accident report may contain one piece of the discovery information and a plurality of pieces of the occurrence information. In the case where a first occurring failure is overlooked in spite of several chances of discovery given before the effect of the particular failure reaches the patient, such an overlook is also reported as a failure. In this case, a plurality of pieces of the occurrence information are reported.

(Step 4): Upon complete input to the incident/accident report input unit S1, the registration process is executed after the approval of the risk manager. The latest incident/accident report that has been given is registered on the report database S2. Incidentally, a system configuration may be such that the registration process and the approval process are executed at the same time.

(Step 5): After execution of the registration process, a screening unit S5 extracts the first occurring failure from a plurality of failures. The process map indicating the flowchart of a series of jobs (tasks) as shown in FIGS. 2 and 4 is accumulated in the process map database S8. In accordance with this process map, the first occurring failure is specified.

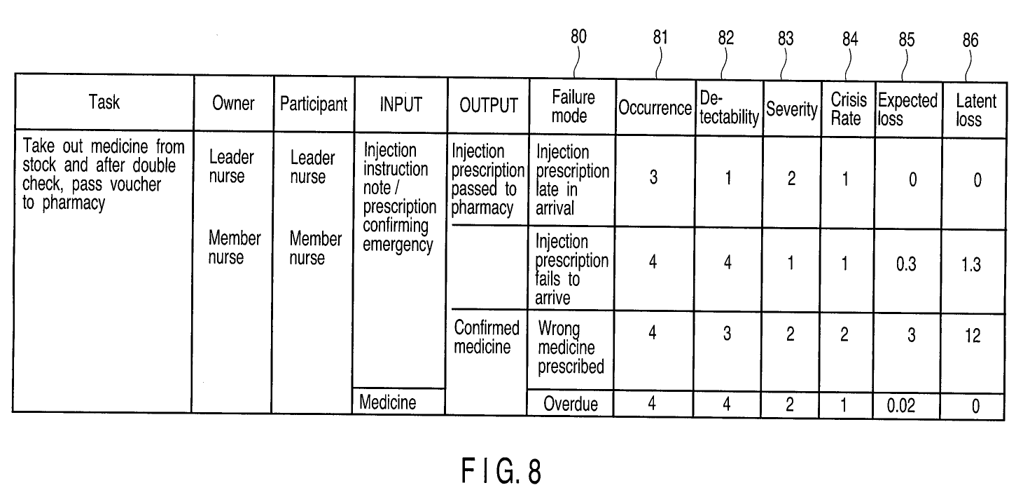

(Step 6): The risk calculation unit S6 utilizes the occurrence information corresponding to the first occurring failure. Based on the failure mode described in the occurrence information, the detectability and the crisis rate stored in the FMEA table S3 are read. An example of the FMEA table S3 is shown in FIG. 8.

In the FMEA table S3 shown in FIG. 8, there are an expected loss 85 and a latent loss 86 in addition to the items of a failure mode 80, an occurrence 81, a detectability 82, an severity 83 and a crisis rate 84. Such an FMEA containing the information useful for risk analysis is referred to as the risk FMEA (RFMEA). Incidentally, the latent loss 86 is the evaluation for each failure mode, and can be calculated from the occurrence 81, the detectability 82, the severity 83 and the crisis rate 84. This latent loss 86 is a value different from the incident risk as a risk calculated from the incident/accident report described below.

(Step 7): The risk calculation unit S6 obtains the loss amount corresponding to the severity from the data table S4 based on the severity in the occurrence information. The risk calculation unit S6 also obtains the numerical values corresponding to the detectability and the crisis rate from the data table S4 based on the detectability and the crisis rate, respectively, shown in the FMEA table S3. The correspondence with the numerical values is shown in FIGS. 5 and 6. The numerical value corresponding to the detectability is referred to as the “detectability probability” and the numerical value corresponding to the crisis rate as the “crisis probability”. The numerical value corresponding to the severity (magnitude of the severity) is referred to as the “loss amount”. Also, the parameters N and α are read from the parameter storage unit S7. As described above, N designates the number of times the failure occurs, and α the risk tolerance parameter stored beforehand in the parameter storage unit S7. Incidentally, the values of these parameters may of course be determined arbitrarily in accordance with a particular embodiment.

(Step 8): Then, the risk calculation unit S6 calculates a probability p as follows, in accordance with whether the incident level of the discovery information is 0a or not lower than 0b. This probability p corresponds to the probability of occurrence of the worst situation on condition that the same incident occurs.

$$\begin{matrix}p = ak ( 0 a ) \\ = k ( not lower than 0 b )\end{matrix} \qquad [ Equation 1 ]$$

where k is the crisis probability and a is the latent probability.

(Step 9): The following steps (9-1) to (9-4) are repeated.

(Step 9-1): j is set to 0 and x to 1, where j is the number of times the worst situation occurs, and x the probability.

(Step 9-2): Equation 2 below is calculated.

x=x−_{N}Cⱼp^{j}(1−p)^{N-j} [Equation 2]

(Step 9-3):

x≦0.01α [Equation 3]

In the case where Equation 3 is satisfied, the process is ended. Otherwise, the process returns to step 9-2 assuming that j=j+1.

(Step 9-4): y (=loss amount×j) is determined.

The value y can be considered the magnitude of the loss accrued with the probability of α% after repetition of the same failure N times, and therefore, constitutes an index to determine the degree of the risk after repetition of the same failure. Thus, y is called the “incident risk” of the failure.

(Step 10): The value of the incident risk y of the failure thus calculated is stored in the report database S2 in correspondence with the incident/accident report.

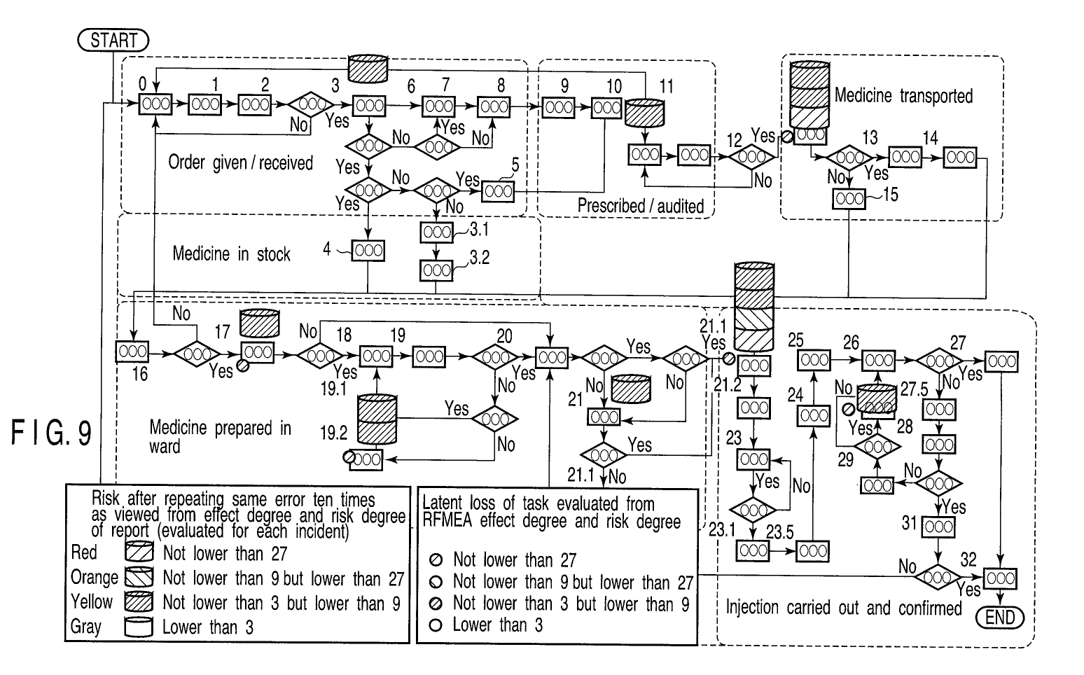

(Step 11): In the display unit S9, the incidents that have occurred are displayed on the corresponding tasks in the process map by designating the process and the period. Each incident is indicated by a cylinder, for example. Desirably, each cylinder is so colored as to make it possible to identify the magnitude of the incident risk of the failure. An example in which a plurality of incidents/accidents occur for one task and cylinders are displayed in stack is shown in FIG. 9.

FIG. 9 shows the result of calculating the incident risk as a loss amount occurring with the probability of 1% when the same failure is repeated ten times. In FIG. 9, the value 27 or more of the incident risk may be indicated, for example, in red, the values 9 to 27 in orange, the values 3 to 9 in yellow and the value less than 3 in gray. Also, apart from cylinders, a colored circle, for example, may be displayed to indicate the latent loss calculated for each task.

As explained above, according to the first embodiment, the incident risk can be calculated as the analysis result of the incident/accident report, and can be displayed in a form easy to understand on the process map.

Although the risk calculation unit S6 has been described above as means for reading the detectability and the crisis rate from the FMEA table S3 as required for calculation of the incident risk, the detectability and the crisis rate may alternatively be input to the incident/accident report input unit S1 together with the incident/accident level (severity). Then, the incident risk can be calculated without referring to the FMEA table S3. As another alternative, the incident risk may be calculated from the crisis rate (crisis probability) and the severity (loss amount) without using the detectability.

### Second Embodiment

A method of analyzing a process by FMEA, though effective for detecting the latent problem point, poses the problem that it is unknown whether the FMEA evaluation results are correct or not. According to the second embodiment, therefore, a hypothesis is set up about the probability with which the effect of the failure reaches the patient for each failure mode from the FMEA evaluation result. Also, the number of times the effect reaches the patient is counted for each failure mode from the report, and whether the hypothesis can be rejected or not is confirmed. In the case where the hypothesis is rejected, one can use an edit function to change the FMEA sheet.

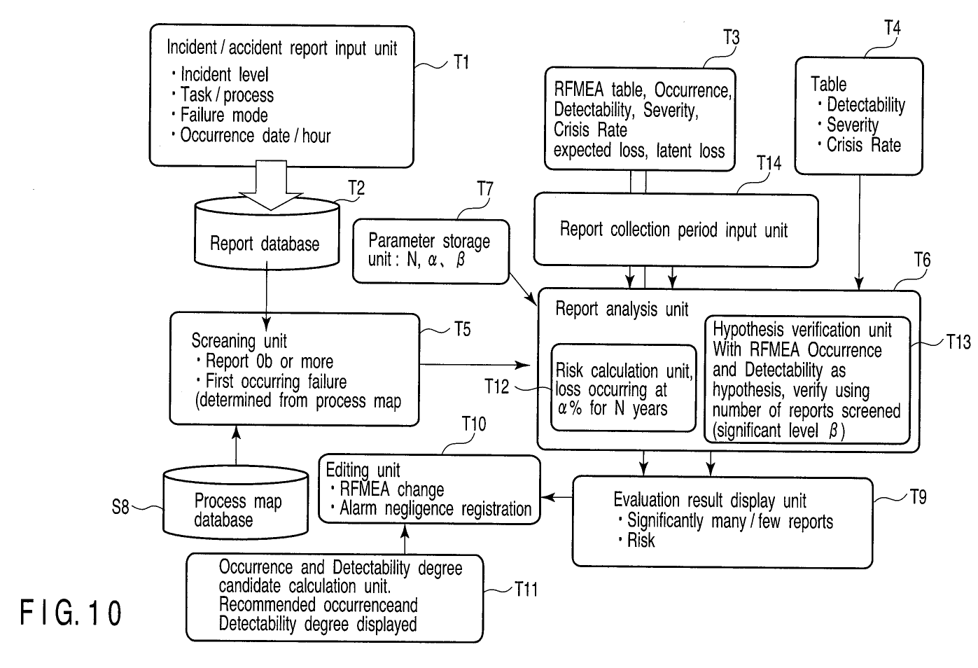

As shown in FIG. 10, the incident/accident report analysis apparatus according to the second embodiment includes an incident/accident report input unit T1 for inputting the incident/accident report, a report database T2 for accumulating the incident reports, a screening unit T5 for screening only the incident reports of which the effect has reached the patient, a FMEA table T3 and a data table T4 for storing the occurrence, detectability, severity and crisis rate.

A hypothesis verification unit T13 of a report analysis unit T6 calculates, from the probability designated in the FMEA table T3, the probability that failures not less than and not more than the number of times the failure occurs obtained from the screening unit T5 for each failure mode. In the case where the aforementioned numerical value is not more than a significant level β, the massages “reports are significantly small/large” are displayed in the evaluation result display unit T9. And there is an editing unit T10 which edits the occurrence or the detectability corresponding to the failure mode. Also, in the editing process, the candidates for the occurrence and the detectability are displayed by a candidate calculation unit T11.

With regard to the hypothesis verification unit T13, assume that the number of times the failure occurs as obtained from the screening unit T5 (the number of times the failure not less than 0b in level actually occurs) is given as M, for example. The probability that M or more failures occur during the measurement period is calculated using the probability (hypothesis) designated in the FMEA table T3. In the case where this probability is small (not higher than the significant level of 5%, for example), the hypothesis is rejected. In the process, a doubt arises that the numerical value of the hypothesis is too small. In other words, failures measured are considered too many. In similar fashion, the probability that M or less failures occur during the measurement period is calculated. In the case where this probability is small (not higher than the significant level of, say, 5%), the hypothesis is rejected. In this case, an excessively large numerical value of the hypothesis is doubted, and the number of failures measured is considered too small.

The steps of operation of the incident/accident report analysis apparatus according to the second embodiment having the aforementioned configuration will be explained below.

(Step 1): The discoverer who has discovered an incident or an accident inputs the discovery information into the incident/accident report input unit T1 (see FIG. 2). As described above, the discovery information contains the effect (incident/accident level) on the patient. The definition of the incident/accident level is the same as that shown in FIG. 3 of the first embodiment. In the second embodiment, the example of handling an incident report is also shown to explain our invention.

(Step 2): The person who has committed an error notes the occurrence information by way of the incident/accident report input unit T1 (see FIG. 4). In this case, the process in which the error has occurred is selected on the screen, and the task for which the failure has occurred is selected on the process map. Then, a table corresponding to the task is displayed on the lower side of the screen. In this table, the radio buttons are selected in the order of the input/output and the failure mode. Further, the severity and the crisis rate are selected. The definition of the severity and the crisis rate is similar to that shown in FIGS. 5 and 6.

(Step 3): The information input from the incident/accident report input unit T1 is accumulated in the report database T2. The information accumulated in the report database T2 is also the same as that shown in FIG. 7.

(Step 4): The incident/accident report input unit T1, upon complete input, executes the registration process after the approval process by the risk manager. The latest incident/accident report given is registered on the report database T2.

(Step 5): The report analysis unit T6 receives the information indicating the report collection period from a report collection period input unit T14, and searches the report database T2 for the data in this period.

(Step 6): The screening unit T5 extracts only the reports having the incident level of 0b or more from among the data searched, and sets up a flag for the occurrence information first occurred in each report in accordance with the information in the process map database T8. The process of setting up the flag may be executed in each time the report is registered.

(Step 7): The report analysis unit T6 executes the following steps (7-1) and (7-2) for all the failure modes of the designated process.

(Step 7-1): While checking whether the failure mode described in the occurrence information with the flag set up in the incident/accident report coincides with the failure mode in the evaluation, the number of coincident reports is counted.

(Step 7-2): The number of coincident reports n_{f} is stored for each failure mode.

(Step 8): In the hypothesis verification unit T13 in the report analysis unit T6, N and β are read from the parameter storage unit T7, and the following steps (8-1) to (8-4) are executed for all the failure modes.

(Step 8-1): The occurrence and the detectability corresponding to the failure mode are acquired from the FMEA table T3. Also, the corresponding numerical values are acquired from the data table T4 (FIG. 5). The numerical value corresponding to the occurrence is called the occurrence probability, and the numerical value corresponding to the detectability the detectability probability.

(Step 8-2): q (=occurrence probability×detectability probability) is calculated. F is set to be zero (F=0) and T is set to be 365(T=365).

(Step 8-3):

$${\sum }_{j = 0}^{{n}_{f}} {}_{T}^{}{C}{}_{j}^{} {{q}_{i}^{j} ( 1 - {q}_{i} )}^{T - j} \leq 0.01 \times β \qquad [ Equation 4 ]$$

In the case where this equation is satisfied, F is set to 1 (reports too few) for the failure mode.

(Step 8-4):

$$1 - {\sum }_{j = 0}^{{n}_{f} - 1} {}_{T}^{}{C}{}_{j}^{} {{q}_{i}^{j} ( 1 - {q}_{i} )}^{T - j} \leq 0.01 \times β \qquad [ Equation 5 ]$$

In the case where this equation is satisfied, F is set to 2 (reports too many) for the failure mode.

(Step 9): A risk calculation unit T12 of the report analysis unit T6 calculates an expected loss and a latent loss in accordance with the number of reports for each failure mode.

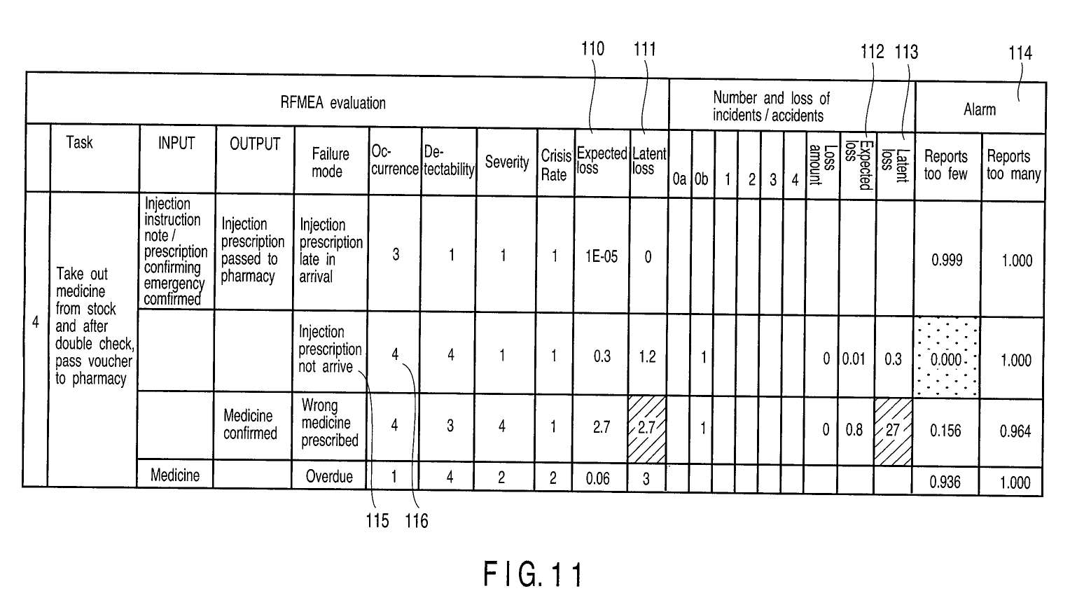

(Step 10): An evaluation result display unit T9 displays the result of calculation in the report analysis unit T6. An example of the display is shown in FIG. 11. In FIG. 11, an expected loss 110 and a latent loss 111 in the RFMEA evaluation are those which have been stored in the FMEA table T3. An expected loss 112 and a latent loss 113 in terms of the number of the incidents/accidents are the values calculated in step 9. Also, the numerical values indicated in an alarm 114 are the values (P values) calculated in steps (8-3) and (8-4), respectively, and in the case where the values are not more than 0.01β, for example, the background is colored in pink. The background color of is the expected loss and the latent loss is also changed in accordance with each value.

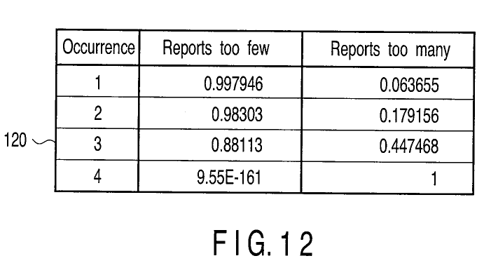

(Step 11): The editing unit T10 can change the occurrence or the detectability corresponding to the failure mode. Upon selection of the occurrence or the detectability, as the case may be, the number of points can be selected. The number of points with alarm and the number of points without alarm are displayed in different colors. For example, if an attempt is made to change a occurrence 116 for a failure mode 115 “no injection prescription has reached” with the alarm in FIG. 11, the selectable numerical values of point 1 to point 4 are displayed. Since point 4 is accompanied by an alarm, the numerical value is red in color, while selection of point 1 to point 3 is accompanied by no alarm, resulting in black. Also, the optimum numerical value is calculated by the occurrence and detectability in the candidate calculation unit T11 and colored in blue. An example of candidate calculation in the candidate calculation unit T11 is shown in FIG. 12. In this case, the manner in which the P value changes with the number of points is calculated. For example, the occurrence of 3 associated with the largest one of the minimum P values between “reports too few” and “reports too many”, can be selected as a recommendation 120.

According to the embodiments of the invention described above, an incident that has actually resulted in a small loss but that has a large latent problem can be evaluated. Also, by totalizing the incidents for each task, a particular task which harbors many problems can be identified at a glance. Further, according to the second embodiment, the contents of FMEA can be verified, and therefore, the legitimacy of the FMEA evaluation can be checked. Also, even in the case where the risk is judged to be high according to FMEA, no report may occur. When the FMEA evaluation result (hypothesis) is not disregarded according to the statistical test, a request can be reasonably made to take a measure even in the absence of a report.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An incident/accident report analysis apparatus comprising:
an input unit which inputs an incident/accident report containing a crisis rate and an severity of an incident/accident;
a data table having recorded therein a probability value corresponding to the crisis rate and a loss amount corresponding to the severity;
a parameter storage unit having stored therein an N value indicating the number of times a failure occurs and an α value indicating a risk tolerance parameter; and
a risk calculation unit which calculates a incident risk including the loss amount occurring with the probability of α% upon repetition of the same failure N times, using the probability value corresponding to the crisis rate and the loss amount corresponding to the severity.

2. An incident/accident report analysis apparatus comprising:
an input unit which inputs a plurality of incident/accident reports;
a report database which accumulates the incident/accident reports;
a FMEA table which records each failure mode in correspondence with at least information on a detectability and a crisis rate;
a data table having recorded therein probability values corresponding to the detectability and the crisis rate, respectively, and a loss amount corresponding to an severity;
a parameter storage unit having stored therein an N value indicating the number of times a failure occurs and an α value indicating a risk tolerance parameter; and
a risk calculation unit which calculates a incident risk including the loss amount occurring with the probability of α% upon repetition of the same failure N times, with reference to the incident reports accumulated in the report database, the FMEA table and the data table,
wherein the incident risk is stored in the report database in correspondence with the incident report.

3. The apparatus according to claim 2, further comprising:
a process map database which accumulates a process map indicating a flowchart of a series of tasks; and
a display unit which totalizes the incident risk based on the incident/accident report for each task and displays the incident risk on the process map.

4. The apparatus according to claim 3,
wherein the display unit displays the incident risk in different manners in accordance with a magnitude of the incident risk based on the incident/accident report.

5. The apparatus according to claim 2,
wherein the risk calculation unit calculates the latent loss for each task failure mode with reference to the FMEA table and the data table, and
the display unit displays the incident loss based on the incident/accident report and the latent loss for each task failure mode.

6. The apparatus according to claim 2, further comprising:
a screening unit which screens only those incident reports accumulated in the report database of which the effect has reached a patient; and
a hypothesis verification unit which determines a hypothesis of a probability that the effect reaches the patient for each failure mode, based on the FMEA table, and verifies whether the hypothesis is to be rejected by counting the number of the incident reports of which the effect reaches the patient,
wherein if the hypothesis is rejected, the display unit displays an alarm that the incident reports significant for the failure mode are too few or too many.

7. The apparatus according to claim 6, further comprising:
an editing unit which edits selected one of the occurrence and the detectability corresponding to the failure mode.

8. An incident/accident report analysis method comprising:
inputting an incident/accident report containing a crisis rate and an severity of an incident/accident through an input unit;
recording a probability value corresponding to the crisis rate and a loss amount corresponding to the severity in advance in a data table;
storing an N value indicating the number of times a failure occurs and an αvalue indicating a risk tolerance parameter in advance in a parameter storage unit; and
calculating through a risk calculation unit a incident risk including the loss amount occurring with the probability of α% upon repetition of the same failure N times, using the probability value corresponding to the crisis rate and the loss amount corresponding to the severity.

9. A computer readable storage medium storing instructions of a computer program which when executed by a computer results in performance of steps comprising:
inputting an incident/accident report including a crisis rate and an severity of an incident/accident;
recording a probability value corresponding to the crisis rate and a loss amount corresponding to the severity in advance in a data table;
storing an N value indicating the number of times a failure occurs and an α value indicating a risk tolerance parameter in advance in a parameter storage unit; and
calculating a incident risk including the loss amount occurring with the probability of α% upon repetition of the same failure N times, using the probability value corresponding to the crisis rate and the loss amount corresponding to the severity.
